(19) United States
(12) Patent Application Publication
(10) Pub. No.: US 2008/0160473 A1
(43) Pub. Date: Jul. 3, 2008

(54) DENTAL ALIGNER SEATING AND REMOVAL TOOL AND METHOD OF USE

(76) Inventors: Chunhua Li, Cupertino, CA (US); Ryan Kimura, San Jose, CA (US); Jennifer C. Chen, San Francisco, CA (US); Kamil P. Brozek, Sunnyvale, CA (US)

Correspondence Address: ALIGN TECHNOLOGY C/O WAGNER BLECHER LLP, 123 WESTRIDGE DRIVE, WATSONVILLE, CA, 95076, US

(21) Appl. No.: 11/617,266

(22) Filed: Dec. 28, 2006

(51) Int. Cl. A61C 7/02

(52) U.S. Cl. 433/3

(57) ABSTRACT

A tool for removing a dental shell appliance from the teeth of a user is disclosed having a distal end with a J-shaped member, the member including an end portion adapted to slide between a dental shell appliance and one or more teeth when the appliance is being worn over the teeth, and a proximal end having a handle, wherein the tool is configured to facilitate removal of the dental shell appliance when the J-shaped member is engaged with the appliance and the handle is pulled away from the teeth.

A combination tool for alternately seating and removing a dental shell appliance relative to teeth of a user is also disclosed, the tool including a proximal end having a generally planar member approximating the size of a dental arch, wherein the tool is configured to facilitate seating of at least one dental shell appliance when the generally planar member is placed between an upper arch and a lower arch of a user before the user bites down on the appliance, and a distal end having a J-shaped member with an end portion adapted to slide between the dental shell appliance and one or more teeth when the appliance is seated on the teeth, wherein the tool is configured to facilitate removal of the dental shell appliance when the J-shaped member is engaged with the appliance and the proximal end is pulled away from the teeth.

Methods involving the use of such tools are also disclosed.

### FIELD OF THE INVENTION

The present invention relates generally to the field of orthodontics.

### BACKGROUND OF THE INVENTION

Orthodontic treatments involve repositioning misaligned teeth and improving bite configurations for improved cosmetic appearance and dental function. As an improvement to traditional braces and other bonded orthodontic equipment, removable elastic positioning appliances have been developed for realigning teeth. Such appliances typically comprise a thin shell of elastic material that generally conforms to a patients teeth but is slightly out of alignment with the initial tooth configuration. Placement of the elastic positioner over the teeth applies controlled forces in specific locations to gradually move the teeth into the new configuration. Repetition of this process with successive appliances with new configurations eventually moves the teeth through a series of intermediate configurations to a final desired configuration. A full description of an exemplary elastic polymeric positioning appliance is provided in U.S. Pat. No. 5,975,893, and in published PCT application WO 98/58596 which designates the United States and which is assigned to the assignee of the present invention. Both documents are incorporated by reference for all purposes.

In addition to their ease of use, polymeric positioning appliances are generally transparent, providing an improved cosmetic appearance. Such appliances impart substantial force on the teeth, due to stiffness of the appliance. The resilient repositioning forces required to move a tooth from one position to another position in a reasonable amount of time may be formidable. The design of appliances capable of imparting such forces with acceptable comfort and appearance has been a challenge. To achieve such forces, the appliance must be relatively stiff (i.e. possess a high strength or high modulus) to provide a sufficient grip on the teeth. The stiffness of an elastic positioning appliance is a result of the modulus of the polymer materials from which it is made. The higher the modulus of the materials, the higher the stiffness of the appliance. The stiffness both ensures that the dental appliance remains firmly in position on the patient's teeth and provides the repositioning force necessary to move the teeth. The stiffness also permits the dental appliance to “grab hold” of dental features which may be present on the tooth to apply a directed force to execute orthodontic tooth movements. When an appliance is positioned over a prescribed group of teeth, one or more of the teeth may provide a base or anchor region for holding the positioning appliance in place while the stiffness of the polymeric material will impart a resilient repositioning force against one or more of the remaining teeth. However, the stiffer the appliance, the more difficult it is to slip the misaligned appliance firmly over the teeth and fully engage the appropriate surfaces. Unless fully seated, a stiff appliance has the tendency to disengage or “pop off”. Likewise, once a stiff appliance is firmly seated, it is more difficult to remove. Attachments may optionally be bonded to the teeth to aid in retaining the appliances on the teeth. These attachment devices may also provide a firm point of purchase through with the appliances can provide tooth moving forces. However, such attachment devices can make it even more difficult to seat the appliances on the teeth and to later remove the appliances.

While stiffer appliances and/or the use of attachments devices bonded to the teeth may be desirable for providing repositioning forces and for maintaining appliance position on the teeth, the removal of appliances in such circumstances may be difficult, particularly when being removed by the patient. Periodic removal is desirable for a number of purposes including cleaning, dental hygiene, removal before meals, removal for cosmetic purposes, and removal and replacement in the course of treatment. In most or all of these cases, however, it will be inconvenient for the patient to visit the practitioner.

For these reasons, it would be desirable to provide tools, methods and systems for easily seating and removing dental appliances from the teeth. Such tools, methods and systems should be economical and, in particular, should reduce the difficulty experienced and the amount of time required by the practitioner and/or patient in removing and subsequently re-applying the appliances.

### SUMMARY OF THE INVENTION

A tool for removing a dental shell appliance from the teeth of a user is disclosed having a distal end with a J-shaped member, the member including an end portion adapted to slide between a dental shell appliance and one or more teeth when the appliance is being worn over the teeth, and a proximal end having a handle, wherein the tool is configured to facilitate removal of the dental shell appliance when the J-shaped member is engaged with the appliance and the handle is pulled away from the teeth.

A combination tool for alternately seating and removing a dental shell appliance relative to teeth of a user is also disclosed, the tool including a proximal end having a generally planar member approximating the size of a dental arch, wherein the tool is configured to facilitate seating of at least one dental shell appliance when the generally planar member is placed between an upper arch and a lower arch of a user before the user bites down on the appliance, and a distal end having a J-shaped member with an end portion adapted to slide between the dental shell appliance and one or more teeth when the appliance is seated on the teeth, wherein the tool is configured to facilitate removal of the dental shell appliance when the J-shaped member is engaged with the appliance and the proximal end is pulled away from the teeth.

Methods involving the use of such tools are also disclosed.

### BRIEF DESCRIPTION OF THE DRAWINGS

FIG. 1 is a top perspective view showing one embodiment of a dental shell appliance positioned above a lower dental arch of a patient.

FIG. 2 is a photograph of one embodiment of an appliance seating and removal tool constructed according to aspects of the present invention.

FIG. 3 is a perspective view of the tool shown in FIG. 2.

FIG. 4 is a top plan view of the tool shown in FIG. 2.

FIG. 5 is a bottom plan view of the tool shown in FIG. 2.

FIG. 6 is a side elevation view of the tool shown in FIG. 2.

FIG. 7 is a perspective view of another embodiment of an appliance seating and removal tool.

FIG. 8 is a side elevation view of the tool shown in FIG. 7.

### DETAILED DESCRIPTION OF THE INVENTION

Before the present appliance seating and removal tools, systems and methods are described, it is to be understood that this invention is not limited to particular tools, systems and methods specifically described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supercedes any disclosure of an incorporated publication to the extent there is a contradiction.

It must be noted that as used herein and in the appended claims, the singular forms “a”, “an”, and “the” include plural referents unless the context clearly dictates otherwise. Thus, for example, reference to “a tooth” includes a plurality of such teeth, and reference to “the appliance” includes reference to one or more appliances and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

While specific reference may be made to a user, patient, practitioner, or other person using the disclosed tools and systems, and practicing the disclosed methods, it is to be understood that such terms are meant to be inclusive of all such users, unless the context clearly dictates otherwise.

In one embodiment of the invention, an appliance removal tool includes a J-shaped hook member at one end of the tool. The J-shaped member has an end portion adapted to slide between the appliance and one or more teeth when the appliance is being worn over the teeth. At an opposite end the appliance may be provided with a handle for holding the tool and for applying force. Once the end portion of the J-shaped member is engaged with the appliance, the appliance may be disengaged from the teeth by pulling the tool away from the teeth.

A tool may be provided with an appliance seating portion. The seating portion may be a generally planar member located at the proximal end of the tool and sized to approximate a patient's dental arches. The seating portion may also be U-shaped to more closely conform to the dental arches. The seating portion of the tool may be used by placing one or more appliances over the teeth, inserting the seating tool between the upper and lower arches and biting down on the seating tool until the appliance(s) is/are fully seated. When seating an appliance over a patient's teeth without the use of a seating tool, such as by simply pushing on the appliance or biting down on it, uneven forces applied to the appliance may bend, crack, mar or otherwise damage the appliance. Moreover, the appliance and/or the patient's opposing teeth may slip when applying such occlusal forces, causing damage to the patient's teeth, gums or adjacent anatomy. The seating portion of this aspect of the invention provides generally even forces across the appliance to avoid such damage and allow easy seating of the appliance.

A tool may be provided with both an appliance removal member and an appliance seating portion. The appliance removal member (i.e. a distal J-shaped end as described above) may be used as a handle when using the tool to seat an appliance. Similarly, the seating portion of the tool (i.e. the generally planar proximal end, which may be U-shaped) may be used as a handle when using the tool to remove an appliance.

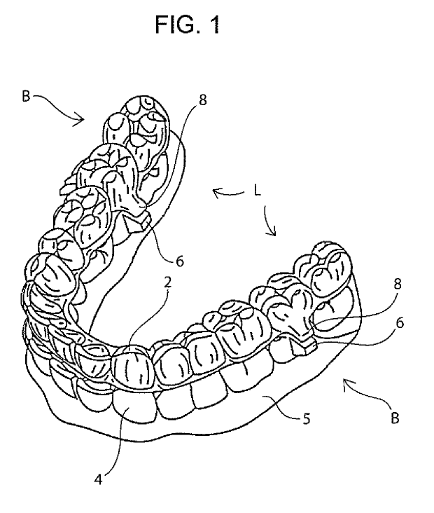

Referring to FIG. 1, one embodiment of a removable dental shell appliance 2 is shown loosely placed over a set of teeth 4 of a lower dental arch before it is fully seated. A portion of the patient's or user's lower gums 5 is also shown. A similar appliance may be provided to fit the teeth of the upper dental arch (not shown) of the patient or user. Appliance 2 may be one of a series of similar appliances designed to incrementally move teeth 4 from an initial position to a final position. A full description of an exemplary elastic polymeric positioning appliance is provided in U.S. Pat. No. 5,975,893, and in published PCT application WO 98/58596 which designates the United States and which is assigned to the assignee of the present invention. Both documents are incorporated by reference for all purposes. Alternatively, appliance 2 depicted in FIG. 1 may be a stand alone appliance, such as a finishing retainer. In some embodiments, appliance 2 may only cover some of the teeth 4 in the dental arch.

In this embodiment, dental appliance 2 comprises a thin, polymeric shell having cavities formed in its underside designed to closely fit over corresponding teeth 4. One or more of the appliance cavities may be slightly misaligned to exert repositioning forces on the tooth or teeth. Appliance 2 typically takes advantage of the natural undercut of many of teeth 4 to resiliently hold appliance 2 in place on the teeth 4. Accordingly, significant force may be required to push appliance 2 onto teeth 4 as the edges of the appliance cavities expand over the wide mid-portion of each tooth, before contracting again over the narrower undercut near the base of the teeth 4 when appliance 2 is fully seated. Similarly, significant force may be required to remove appliance 2 from teeth 4 once the appliance is gripping the undercuts of the teeth. The resilient force that appliance 2 may apply to the undercut of teeth 4 not only helps retain the appliance on the teeth, it is also helpful in certain types of tooth movements, such as extrusions.

Attachment devices 6 and/or other dental fittings may optionally be used in conjunction with appliance 2 to assist in removably securing appliance 2 to teeth 4 and/or to apply particular forces from appliance 2 to teeth 4. In some circumstances, certain forces such as tooth rotation may be difficult to apply to teeth 4 without the use of attachment devices 6. Attachment devices 6 may be semi-permanently bonded to teeth 4 while orthodontic treatment is taking place. Appliance 2 may be formed with corresponding pockets 8 shaped to snap onto attachment devices 6. In order to apply a resilient tooth repositioning force from pocket 8 to attachment device 6, the two features may be designed to be slightly misaligned relative to one another. This snap fit and possible misalignment may require that additional force be used when seating and removing appliance 2.

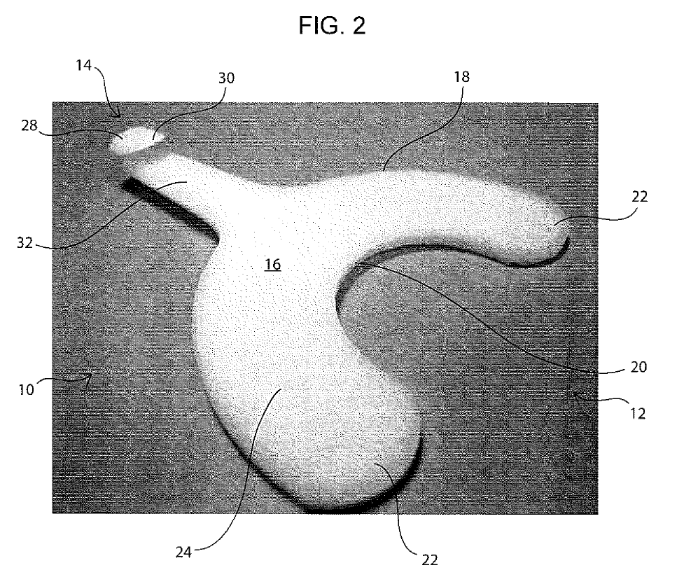

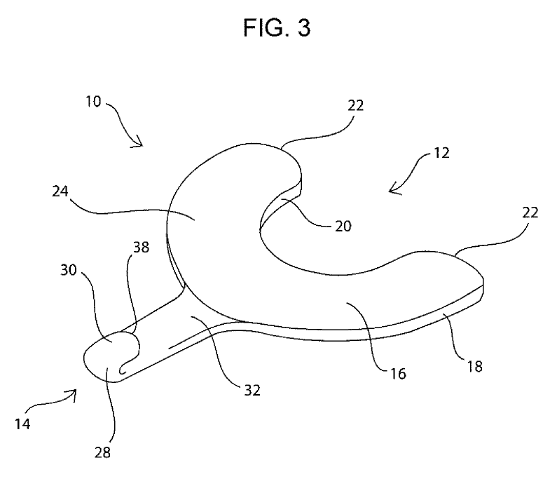

Referring to FIGS. 2-3, an exemplary embodiment of a combination seating and removal tool will now be described. In this embodiment, combination tool 10 is Y-shaped having a proximal end 12 and a distal end 14. Proximal end 12 may have a generally planar appliance seating member 16 sized and shaped to correspond to the geometry of a typical dental arch. In this embodiment, seating member 16 has a rounded outer edge 18. Seating member 16 may have a thickness of about 2.3 mm, and outer edge 18 may have a radius of about 27 mm. Alternatively, different size tools (not shown) may be provided for different size dental anatomies. For example, a tool having a small outer radius may be provided for use with children, a tool having a medium outer radius provided for teenagers, and a tool having a large outer radius provided for adults. Seating member 16 may be U-shaped as shown, also having a rounded inner edge 20. Inner edge 20 may have a radius of about 12.5 mm. In this embodiment, the ends 22 of the U-shaped seating member 16 are also rounded, having a radius of about 8 mm. In other embodiments, seating member 16 may be circular, semi-circular, oval or have another shape other than U-shaped. In still other embodiments, seating member 16 may be omitted altogether and replaced with a handle portion, allowing a user to grasp the tool for using a removal device located on an opposite end, as will be later described.

In use as an appliance seating device, tool 10 may be grasped by its distal end 14. One or more dental shell appliances 2 (shown in FIG. 1) may be loosely placed over an upper dental arch, a lower dental arch or both. The seating member 16 of tool 10 may then be placed horizontally in the patient's mouth such that it is located between the upper and lower arches. As the patient bites down on the seating member, the appliance(s) 2 may be pushed into a fully seated position on the patient's teeth 4 by the occlusal force of the opposing dental arch forcing the seating member 10 against the appliance 2.

To cushion the shell appliance 2 and the opposing teeth, and to aid in distributing occlusal forces across the dental arches, seating member 10 may comprise an elastic or compliant material. For example, upper surface 24 and/or lower surface 26 (shown in FIG. 5) of seating member 16, or the entire seating member 16, can be made of a rubber, a rubberized plastic or another elastomer. In one embodiment, a Kraton® G SEBS/SEPS polymer is used, provided by Kraton Polymers, LLC of Houston Tex.

To facilitate unseating and removal of an appliance 2, a J-shaped member 28 may be located at the distal end 14 of combination tool 10. J-shaped member 28 may be configured with an end portion 30 that may easily be slid between an appliance 2 and a patient's teeth 4 (shown in FIG. 1) to separate appliance 2 from teeth 4. Seating member 16 may be used as a handle to pull J-shaped member 28 away from teeth 4 to unseat appliance 2.

Tool 10 may be configured to engage appliance 2 from any point along its length from either the buccal side or lingual side, designated in FIG. 1 by B and L, respectively. Alternatively, tool 10 may be optimized to engage appliance 2 from a particular side and/or from a particular region, such as the molar region(s) at either end of appliance 2. Such optimization may be achieved, for example, by placing a bend in a middle region 32 of tool 10.

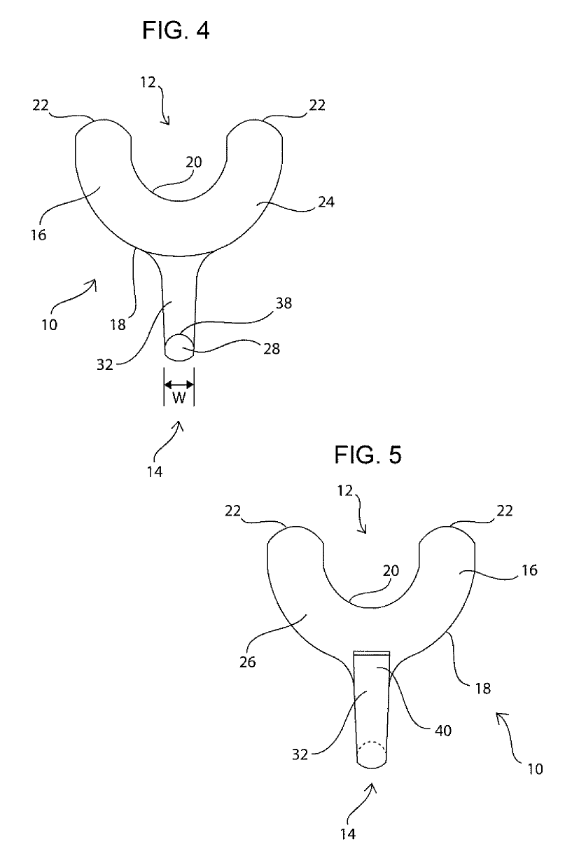

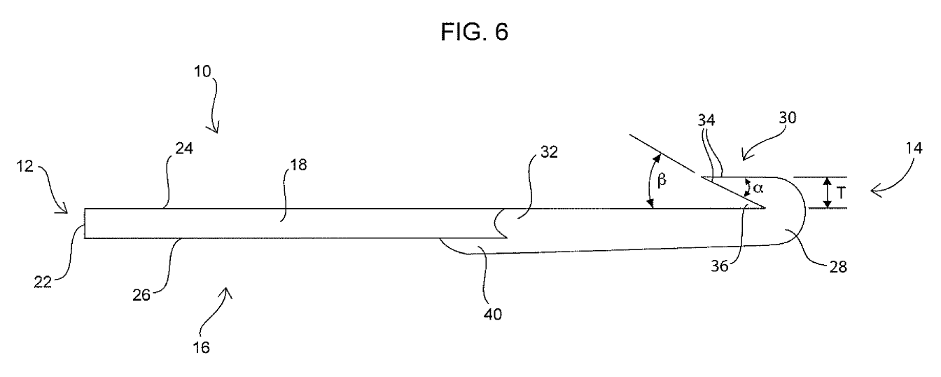

Referring now to FIGS. 4-6, further details of J-shaped member 28 will be described. End portion 30 may be tapered, as shown in FIG. 6, allowing appliance 2 to be gently wedged away from teeth 4 as end portion 30 is slid between appliance 2 and teeth 4, shown in FIG. 1. Tapered surfaces 34 may be straight as shown. In other embodiments, one or both tapered surfaces may be inwardly or outwardly curved, or comprise a combination of curved and straight sections. In the embodiment shown in FIG. 6, tapered surfaces 34 form an angle α. In some embodiments, angle α may be between about 10 degrees and about 45 degrees. In one particular embodiment angle α is about 20 degrees. In the embodiment shown in FIG. 6, end portion 30 forms a V-shaped notch 36 with the remainder of J-shaped member 28. In other embodiments, a U-shaped notch, a square or round-bottomed channel, or other shapes may be formed. In the embodiment shown in FIG. 6, V-shaped notch 36 forms an angle β of about 20 degrees.

End portion 30 has a maximum width, as designated by W in FIG. 4. End portion 30 also has a maximum thickness, as designated by T in FIG. 6. End portion 30 may be dimensioned such that its maximum width W is substantially larger than its maximum thickness T. Such an arrangement has been found to provide greater ease of use and comfort when inserting the end portion between an appliance and the patient's teeth, and less chance of damage to the appliance or injury to the patient when applying removal forces. In one embodiment, the end portion has a maximum width W that is at least three times larger than the maximum thickness T.

As best seen in FIG. 4, end portion 28 may be provided with a rounded leading edge 38. Advantages to using a rounded edge 38 include ease of advancing end portion 28 between appliance 2 and teeth 4 as previously described, and permitting tool 10 to be positioned in a broader range of orientations during use as an appliance removal tool. In certain embodiments, rounded edge 38 of end portion 30 has a radius in a range of about 1 mm to about 25 mm. In one particular embodiment, edge 38 has a radius of about 5 mm.

Tool 10 may be constructed from a plurality of materials. In one embodiment, a generally rigid material forms a skeleton of the tool. A softer, more compliant material is then formed over the generally rigid skeleton. The softer material may cover the entire tool, or just portions such as the generally planar proximal end and part of the J-shaped distal end. In other embodiments, entire portions of the tool, such as the generally planar proximal end, are made of a softer material, while other portions of the tool, such as the J-shaped distal end, are made of a more rigid material. In some of these embodiments, the softer material is a rubber or a rubberized plastic, while the more rigid material is a biocompatible thermoplastic.

J-shaped member 28 should be made of material(s) rigid enough to allow a stiff appliance 2 to be unseated from teeth 4. In one embodiment, J-shaped member 28 is made from a fairly rigid, biocompatible thermoplastic such as polypropylene. In another embodiment, J-shaped member 28 comprises an inner structure made of a fairly rigid material covered with a more compliant material, such as a Kraton® G SEBS/SEPS polymer, provided by Kraton Polymers, LLC of Houston Tex. In one particular embodiment, the entire J-shaped member 28 is covered with a compliant material except for a region of the end portion 30, such as leading edge 38, where a more rigid core material is exposed.

As described above, combination tool 10 may include an appliance seating member 16 on proximal end 12 and/or an appliance removal member 28 on distal end 14. In the embodiment shown, combination tool 10 is formed in a single unitary piece. In alternative embodiments, the appliance seating tool and the appliance removal tool may be formed separately and may be detachably connected together. In the embodiment shown in the figures, tool 10 includes a buttress portion 40 where middle region 32 joins with seating member 16. Buttress portion 40 serves to strengthen the connection between the two halves of tool 10 and provides a thicker region for the user to grasp when using tool 10.

Tool 10 may be provided separately to end user's and/or practitioners. Alternatively, tool 10 may be packed with an appliance 2, or provided with a series of appliances. These tools, systems or sets may also include printed or other instructions on the use of tool 10 with the appliance(s).

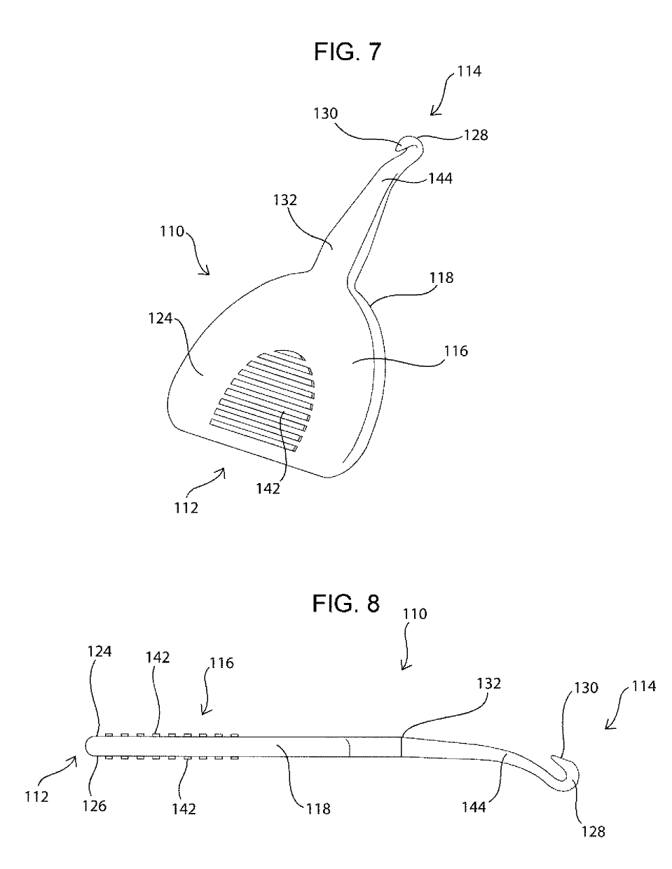

Referring to FIGS. 7 and 8, an alternative embodiment of an appliance seating and removal tool 110 is shown. Tool 10 is similar in construction and operation to tool 10 shown in FIGS. 2-6 and described above, with similar features designated with the same reference numerals incremented by 100. It can be seen from FIG. 7 that seating member 116 of tool 110 is D-shaped, rather than U-shaped as in the previous embodiment. One advantage to the D-shaped seating member 116 is that more contiguous surface area is available for the user to grip tool 110 when using the appliance removal portion of the tool. To further aid the user in gripping tool 110, gripping features may be added to the tool. For example, raised ribs 142 may be provided on one or both sides of seating member 1116, as shown in FIGS. 7 and 8. Alternatively or in combination with ribs 142, other gripping features may be employed, such as grooves or undercut radii. The gripping features may extend across the entire surface(s) of seating member 116, or just a central portion as shown in FIG. 7, leaving a peripheral portion of seating member 116 generally flat where contact is made with the patient's teeth. Gripping features may be made from the same material as adjacent portions of tool 110, or made from another material, such as a softer rubber.

The middle region 132 of tool 110 may also include a bent portion 144. One advantage to including bent portion 144 is to facilitate placing J-shaped member 128 in a more vertical position inline with an edge of an appliance when tool 110 is being used to remove the appliance, while also allowing proximal end 112 to extend away from the user for easier gripping. Bent portion 144 may be formed with a fixed predetermined angle, or it may remain bendable so that it may be reconfigured by the user.

As can be seen in FIGS. 7 and 8, the J-shaped member 128 of tool 110 may be made narrower and rounder than that of tool 10 of the previous embodiment to form more of a point at its end portion 130. It can also be seen that the internal channel of J-shaped member 128 may be constructed with generally parallel surfaces, with a tapered surface located on the exterior rather than the interior of J-shaped member 128.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A tool for removing a dental shell appliance from the teeth of a user, the tool comprising:
a distal end having a J-shaped member, the member including an end portion adapted to slide between a dental shell appliance and one or more teeth when the appliance is being worn over the teeth; and
a proximal end having a handle, wherein the tool is configured to facilitate removal of the dental shell appliance when the J-shaped member is engaged with the appliance and the handle is pulled away from the teeth.

2. The tool of claim 1, wherein the end portion of the J-shaped member has a maximum width and a maximum thickness, and wherein the maximum width is substantially larger than the maximum thickness.

3. The tool of claim 2, wherein the maximum width is at least three times larger than the maximum thickness.

4. The tool of claim 1, wherein the end portion of the J-shaped member is tapered.

5. The tool of claim 1, wherein the end portion of the J-shaped member has a rounded leading edge.

6. The tool of claim 5, wherein the leading edge has a radius in a range of about 1 mm to about 25 mm.

7. The tool of claim 1, wherein the end portion of the J-shaped member is tapered and has a rounded leading edge.

8. The tool of claim 1, wherein the handle is U-shaped.

9. The tool of claim 8, wherein the U-shaped handle is configured to approximate the general shape of a dental arch, thereby allowing the handle to also serve as a dental shell appliance seating tool when inserted between the upper and lower arches of the user before the user bites down.

10. The tool of claim 9, wherein the U-shaped handle includes a material that is more compliant than a material used to form the end portion of the J-shaped member.

11. The tool of claim 10, wherein the U-shaped handle includes a rubber or rubberized plastic and the end portion of the J-shaped member includes a biocompatible thermoplastic.

12. A tooth positioning system comprising at least one removable dental shell appliance and a tool according to claim 1.

13. A combination tool for alternately seating and removing a dental shell appliance relative to teeth of a user, the tool comprising:
a proximal end having a generally planar member approximating the size of a dental arch, wherein the tool is configured to facilitate seating of at least one dental shell appliance when the generally planar member is placed between an upper arch and a lower arch of a user before the user bites down on the appliance; and
a distal end having a J-shaped member, the 3-shaped member having an end portion adapted to slide between the dental shell appliance and one or more teeth when the appliance is seated on the teeth, wherein the tool is configured to facilitate removal of the dental shell appliance when the J-shaped member is engaged with the appliance and the proximal end is pulled away from the teeth.

14. The combination tool of claim 13, wherein the generally planar member is U-shaped and configured to approximate the general shape of the dental arches.

15. The tool of claim 13, wherein the generally planar member includes a material that is more compliant than a material used to form the end portion of the J-shaped member.

16. The tool of claim 15, wherein the generally planar member includes a rubber or rubberized plastic and the end portion of the J-shaped member includes a biocompatible thermoplastic.

17. A tooth positioning system comprising at least one removable dental shell appliance and a combination tool according to claim 13.

18. A method of seating and unseating a dental shell appliance performed by a patient, the method comprising:
placing a removable dental shell appliance over the patient's teeth;
inserting a generally planar portion of a combination tool between the patient's upper and lower arches;
biting down on the generally planar portion to seat the appliance on the teeth;
after a predetermined period of time, inserting a hook-shaped portion of the combination tool between the appliance and the teeth; and
unseating the appliance by pulling on the combination tool.

19. The method of claim 18, wherein the generally planar portion of the combination tool is U-shaped and serves as a handle for pulling in the unseating step.

20. The method of claim 18, further comprising the step of initially removing the dental shell appliance and the combination tool from packaging containing both the appliance and the tool.
